(19) United States
(12) Patent Application Publication
(10) Pub. No.: US 2018/0129740 A1
(43) Pub. Date: May 10, 2018

(54) PLAYLIST MAKING DEVICE

(71) Applicant: Onkyo Corporation, Osaka (JP)

(72) Inventors: Nobuya TACHIMORI, Osaka (JP); Honami HIRATA, Osaka (JP); Atsushi MORIMOTO, Tokyo (JP)

(21) Appl. No.: 15/713,666

(22) Filed: Sep. 24, 2017

(30) Foreign Application Priority Data
Nov. 8, 2016 (JP) 2016-217825

(51) Int. Cl. G06F 17/30

(52) U.S. Cl. CPC G06F 17/30772; G06F 3/147; G06F 17/30778

(57) ABSTRACT

To reflect information of check (selection) to a contents list correctly. A CPU 2 makes a playlist managing database that manages a playlist in a RAM 4. The CPU 2 registers information of a song that selection is received in the playlist managing database. The CPU 2 combines the song database with the playlist managing database. The CPU 2 issues SQL to the combined database and obtains a song list to which a state of addition to the playlist is reflected.

### BACKGROUND OF THE INVENTION

### 1. Field of the Invention

The present invention relates to a playlist making device that makes a playlist that designates reproducing order of contents.

### 2. Description of the Related Art

A smartphone into which a music reproducing program is installed functions as a music reproducing device that plays music. Some of music reproducing devices can make a playlist that designates reproducing order of contents (for example, see JP 2012-155792 A). In the music reproducing device, as illustrated in FIG. 15, there is a case where a system that a user checks (selects) multiple contents that are added to the playlist from a content list such as albums and artists is used. In this system, when all of contents of an album are checked (selected) in the content list, the album should be checked.

However, in a number of music reproducing programs, if all of contents in an album are checked (selected) in the content list, the album is not checked and a correct state is not reflected. Even if the correct state is reflected to the content list, when synchronous processing of contents is operated in background, the correct state cannot be reflected because a database that manages contents changes by the minute.

### SUMMARY OF THE INVENTION

An objective of the present invention is to reflect information of check (selection) to a contents list correctly.

In the present invention, a playlist making device comprising: an auxiliary storage section that stores a content database that manages information of contents; a main storage section; and a controller; wherein the controller makes a playlist managing database that manages a playlist in the main storage section, registers information of a content that selection is received to the playlist managing database, combines the content database with the playlist managing database, issues a command to a combined database, and obtains a content list to which a state of addition to the playlist is reflected.

In the present invention, a controller combines a content database in a main storage section with a playlist managing database in an auxiliary storage section. And, the controller issues a command to a combined database, and obtains a content list to which a state of addition to a playlist is reflected. Like this, information of check (selection) can be reflected to the content list correctly because a database is made in the main storage section and processing of the database can be performed quickly.

Preferably, wherein the controller obtains path of a content from the playlist managing database based on identification information of the content that selection is received and registers the obtained identification information and the obtained path of the content in the playlist managing database.

Preferably, wherein the controller receives selection of a content that is added to the playlist from information of the contents that the content database manages, obtains the path of the content from the playlist managing database based on the identification information of the content that selection is received when it receives selection of a content that is added to the playlist from information of the contents that the content database manages, and registers the obtained identification information of the content and the obtained path of the content to the playlist managing database.

Preferably, wherein the controller registers information of the contents in managed folders to the content database, receives selection of a content that is added to the playlist from the contents in the folder, obtains the path of the content that selection is received when it receives selection of the content that is added to the playlist from the contents in the folder, obtains identification information of the contents from the content database based on the path of the obtained content, and registers the obtained path of the content and the obtained identification information of the content in the playlist managing database.

There is a case where a selected content is not registered in the content database when a content is selected from folders because information of a content in managed folders is registered in the content database. For this reason, path is needed to specify the content. Therefore, when the controller receives selection of a content from contents in the folder, it obtains path of the content that selection is received. Further, the controller obtains identification information of the content from the content database based on the obtained path of the content. And, the controller registers the obtained path of the content and the obtained identification information of the content in the playlist managing database. Thus, it is displayed that the content that is selected from the folder is already checked (selected) in the content list. Reverse is also the same.

Preferably, wherein the controller registers the obtained path of the content and identification information of the content that indicates invalid when it cannot obtain identification information of the content from the content database based on the obtained path of the content.

Preferably, wherein the controller destroys the playlist managing database after it makes the playlist.

Preferably, wherein the command is SQL.

In the present invention, a storage medium in which a playlist making program is stored, the playlist making program for allowing a controller of a computer comprising: an auxiliary storage section that stores a content database that manages information of contents; a main storage section; and the controller; to make playlist managing database that manages a playlist in the main storage section, to register information of a content that selection is received to the playlist managing database, to combine the content database with the playlist managing database, to issue a command to a combined database, and to obtain a content list to which a state of addition to the playlist is reflected.

According to the present invention, information of check (selection) can be reflected to a content list correctly.

### BRIEF DESCRIPTION OF THE DRAWINGS

FIG. 1 is a block diagram illustrating a configuration of a DAP according to an embodiment of the present invention.

FIG. 2 is a diagram illustrating one example of a song database.

FIG. 3 is a diagram illustrating one example of a playlist managing database.

FIG. 4 is a diagram for describing combination of database.

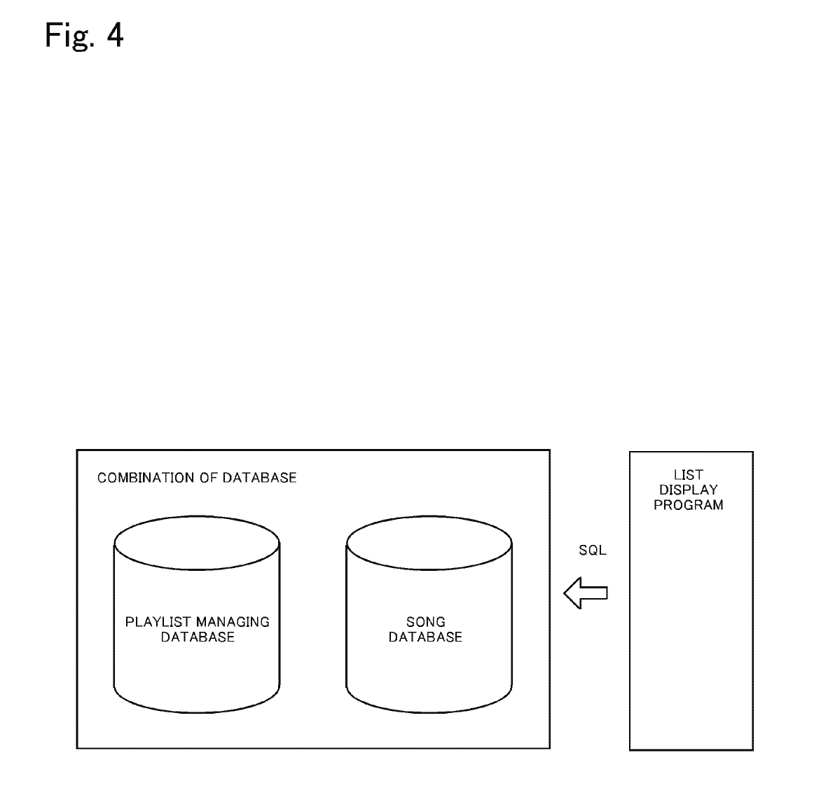

FIG. 5 is a flow chart illustrating processing operation in the case where the DAP performs playlist addition processing.

FIG. 6 is a flow chart illustrating processing operation in the case where the DAP performs check processing.

FIG. 7 is a flow chart illustrating processing operation in the case where the DAP performs list obtaining processing.

FIG. 8 is a diagram illustrating a display example of a song list.

FIG. 9 is a diagram illustrating a display example of a song list.

FIG. 10 is a flowchart illustrating processing operation in the case where the DAP performs playlist save processing.

FIG. 11 is a diagram illustrating a playlist managing database.

FIG. 12 is a flow chart illustrating processing operation in the case where the DAP performs song selection processing from artists, albums or the like.

FIG. 13 is a flow chart illustrating processing operation in the case where the DAP performs song selection processing from a folder.

FIG. 14 is a flow chart illustrating processing operation in the case where the DAP performs song release processing.

FIG. 15 is a diagram illustrating a display example of a content list.

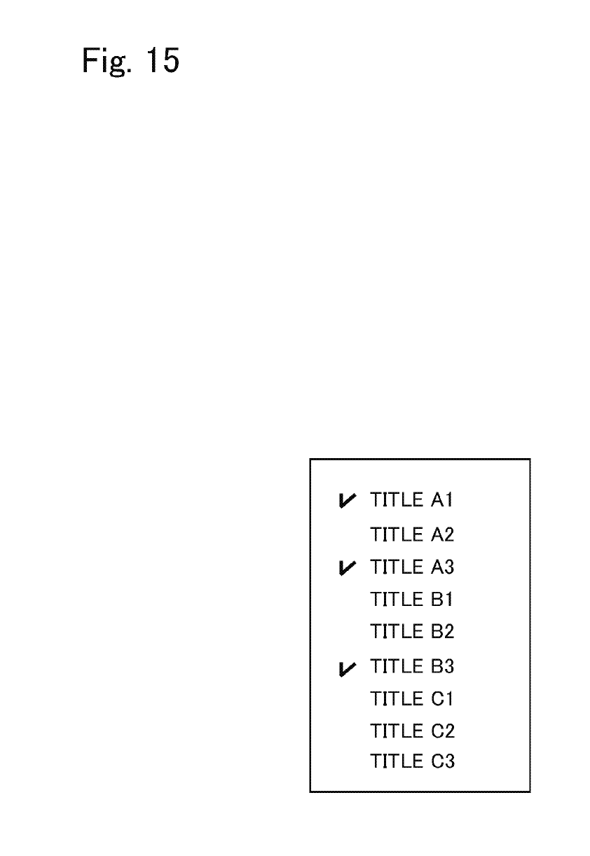

### DETAILED DESCRIPTION OF THE PREFERRED EMBODIMENTS

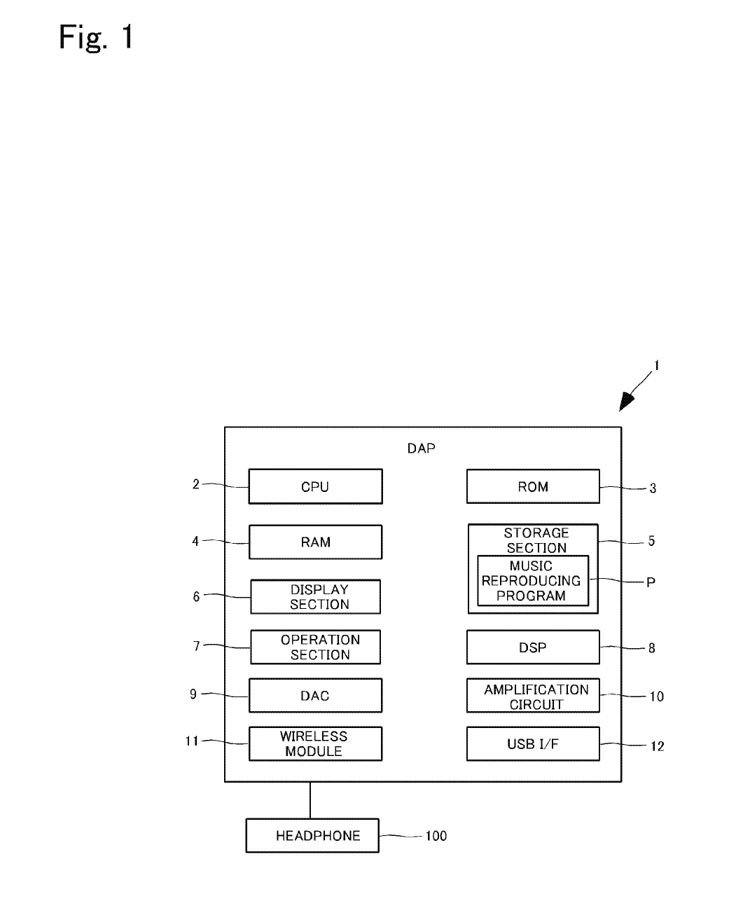

An embodiment of the present invention is described below. FIG. 1 is a block diagram illustrating a configuration of a digital audio player (hereinafter referred as to “DAP”) according to an embodiment of the present invention. The DAP 1 functions as a music reproducing device that reproduces music by executing a music reproducing program P (playlist making program) that is stored in a storage section 5. As illustrated in FIG. 1, the DAP 1 (playlist making device) includes a CPU (Central Processing Unit) 2, a ROM (Read Only Memory) 3, a RAM (Random Access Memory) 4, the storage section 5, a display section 6, an operation section 7, a DSP (Digital Signal Processor) 8, a D/A convertor (hereinafter referred as to “DAC”) 9, an amplification circuit 10, a wireless module 11, and a USB interface (hereinafter referred as to “USB I/F”) 12.

The CPU 2 controls respective sections composing the DAP 1 according to a control program, an OS program, and application programs including the music reproducing program P. The ROM 3 stores the control program. The RAM 4 functions as a main memory of the CPU 2. The CPU 2 can access the RAM 4 directly. The storage section 5 is a flash memory that stores programs such as the OS program and application programs including the music reproducing program P, and various data such as digital audio data. The CPU 2 cannot access the storage section 5 directly. The storage section 5 is not limited to the illustrated configuration, and may be an HDD (Hard Disk Drive). Further, the storage section 5 includes an external storage device such as a micro SD card.

The display section 6 is for displaying various images (including still images and moving images) and composed of a liquid crystal panel. The operation section 7 includes operation keys that are for performing various settings and a touch panel that is linked with the display section 6. A user can perform various character inputs and settings via the operation section 7. Further, the user can make a playlist via the operation section 7.

The DSP 8 performs signal processing such as equalizer processing to digital audio data. The DAC 9 D/A-converts digital audio data into analog audio data. The amplification circuit 10 amplifies analog audio data into which the DAC 9 D/A-converts and outputs amplified analog audio data to a headphone 100. The wireless module 11 is for performing wireless communication according to Bluetooth (registered trademark) standard and Wi-Fi standard. The DAP 1 can communicate with the other devices via the wireless module 11. The USB I/F 12 is for performing communication according to USB standard. The DAP 1 can communicate with a personal computer via the USB I/F 12.

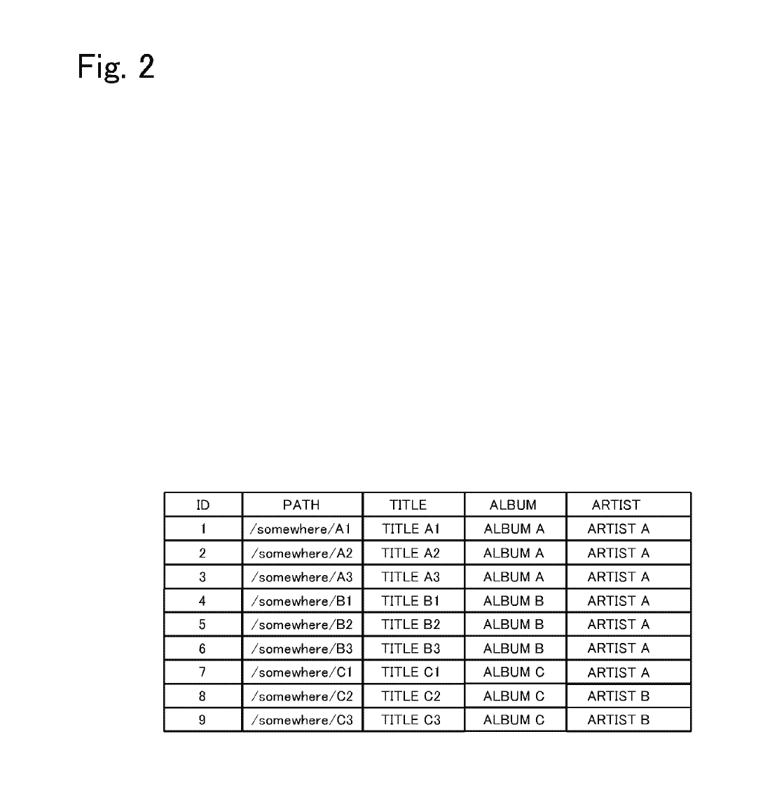

The storage section 5 (auxiliary storage section) stores a song database that manages information of songs (contents). FIG. 2 is one example of the song database. As illustrated in FIG. 2, in the song database, IDs of songs (identification information), paths that illustrate location in which songs are stored, titles of songs, album names including songs, and artist names of songs are stored. The song database manages information such as albums and artists that are displayed in the song list. Tag information in the song is analyzed when adding the song to managed folders and information that is stored in the song database is made.

### First Embodiment

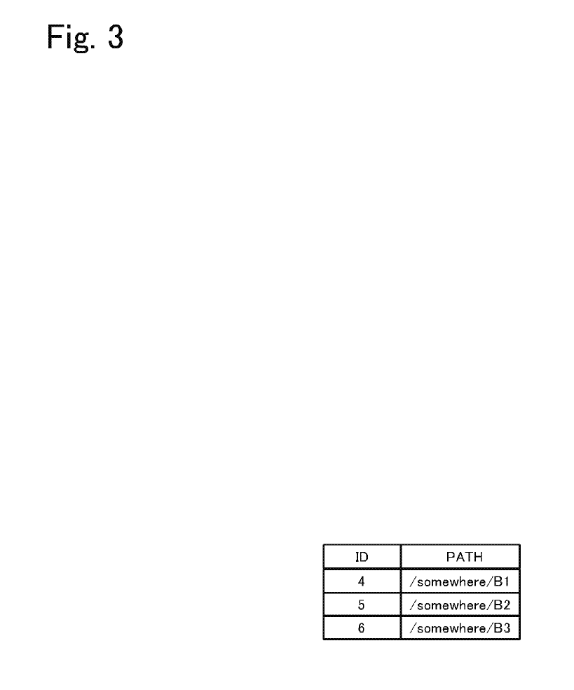

When the CPU 2 receives making direction of the playlist via the operation section 7 in a state activating the music reproducing program P, it makes the playlist that designates reproducing order of songs based on user operation. When the CPU 2 receives making direction of the playlist, it makes the playlist managing database in the RAM 4 (main storage section) first. FIG. 3 is one example of the playlist managing database. As illustrated in FIG. 3, IDs and paths that selection to be added to the playlist is received are stored in the playlist managing database. When making the playlist, the playlist managing database is made temporarily and manages IDs and paths of songs that are added to the playlist. The playlist managing database is destroyed after making the playlist.

When the CPU 2 obtains the song list, it combines the playlist managing database that is stored in the RAM 4 with the song database stored in the storage section 5 according to a list display program that is included in the music reproducing program P. The CPU 2 obtains the song list to which a state of addition to the play list is reflected by issuing SQL (command) to the combined database.

The CPU 2 receives selection of a content that is added to the playlist from information of contents that the song database manages. Further, when the CPU 2 receives selection of the content that is added to the playlist from information of contents that the content database manages, it obtains path of the content from the playlist managing database based on ID of the content that selection is received. Further, the CPU 2 registers the obtained ID of the content and the obtained path of the content in the playlist managing database.

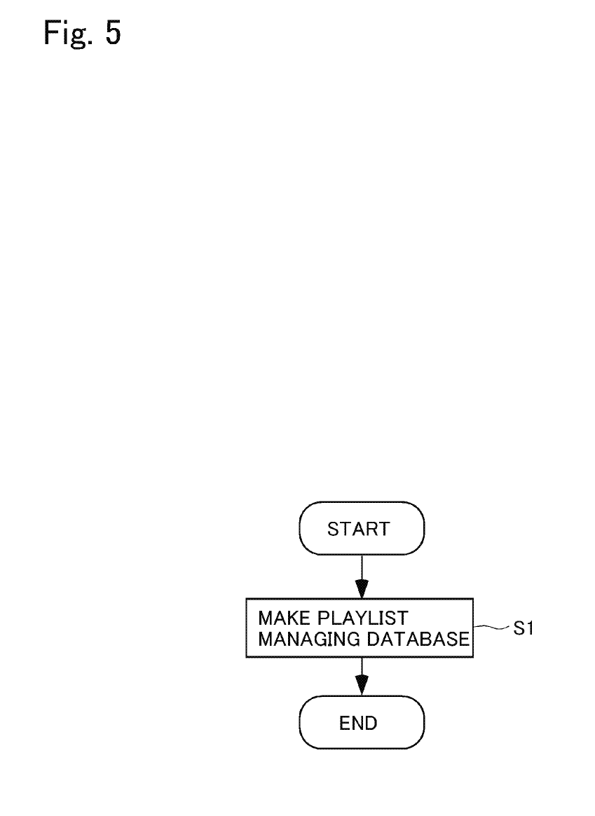

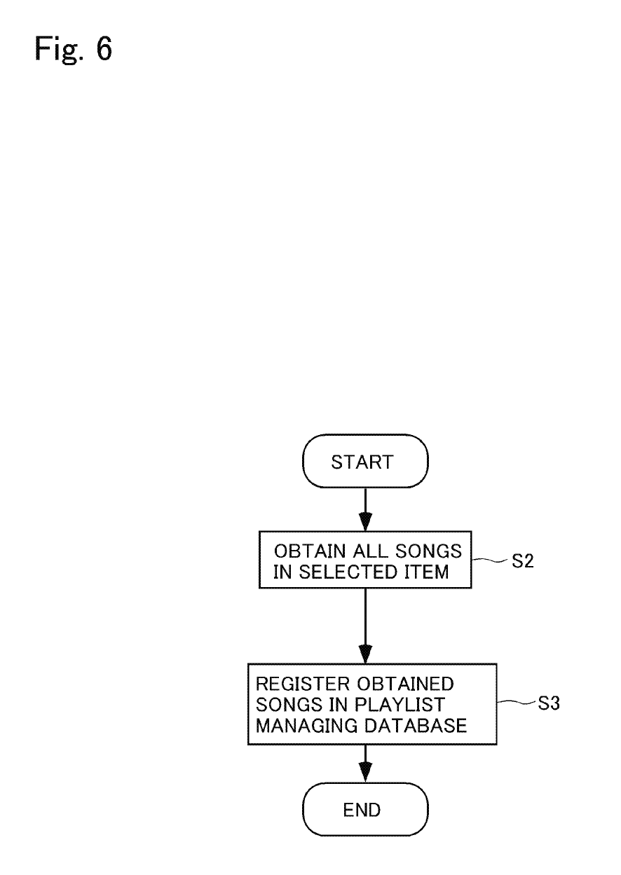

FIG. 5 is a flow chart illustrating processing operation in the case where the DAP 1 performs playlist addition processing. As illustrated in FIG. 5, the CPU 2 makes the playlist managing database in the RAM 4 (S1). FIG. 6 is a flow chart illustrating processing operation in the case where the DAP 1 performs check processing. As illustrated in FIG. 6, the CPU 2 obtains all songs in selected item (S2). Next, the CPU 2 registers obtained songs in the playlist managing database (S3).

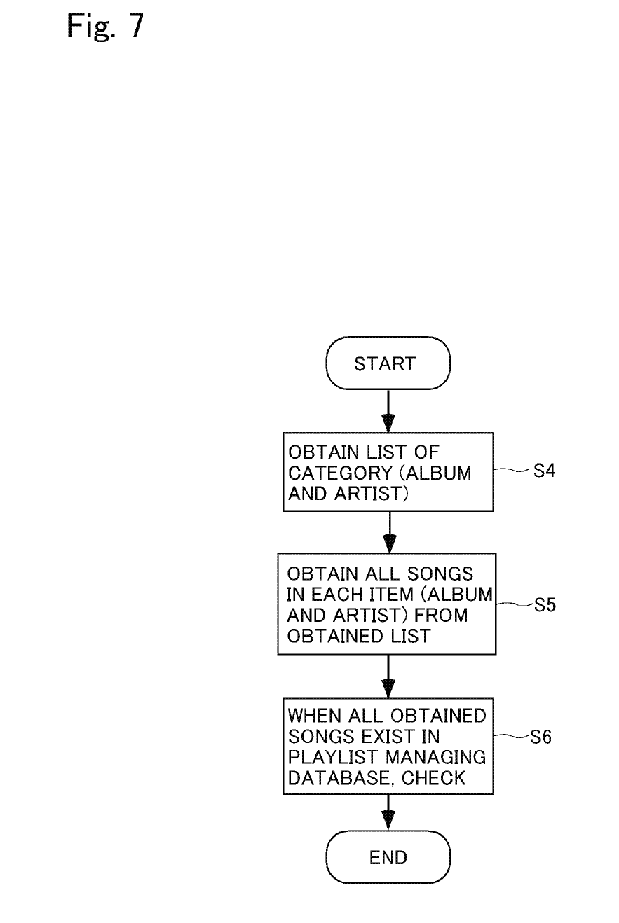

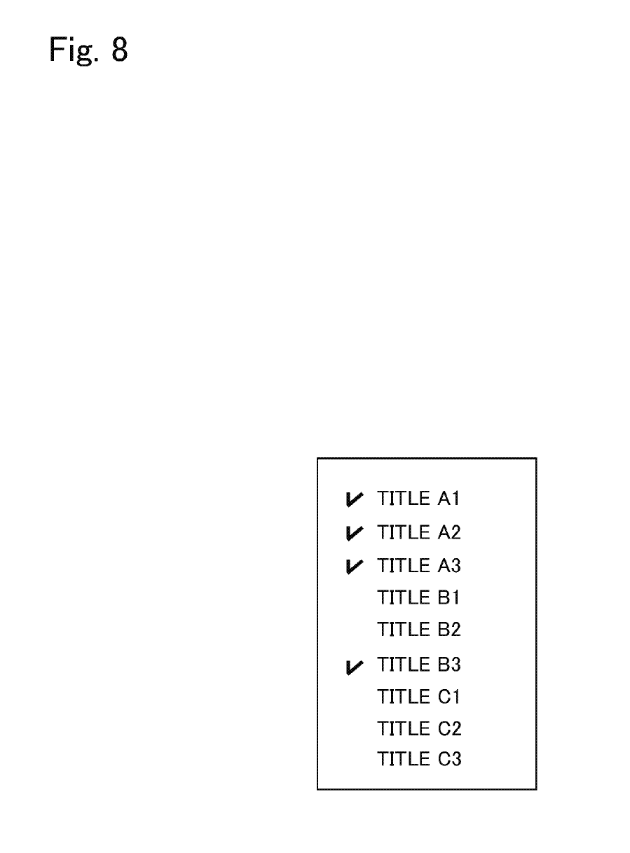

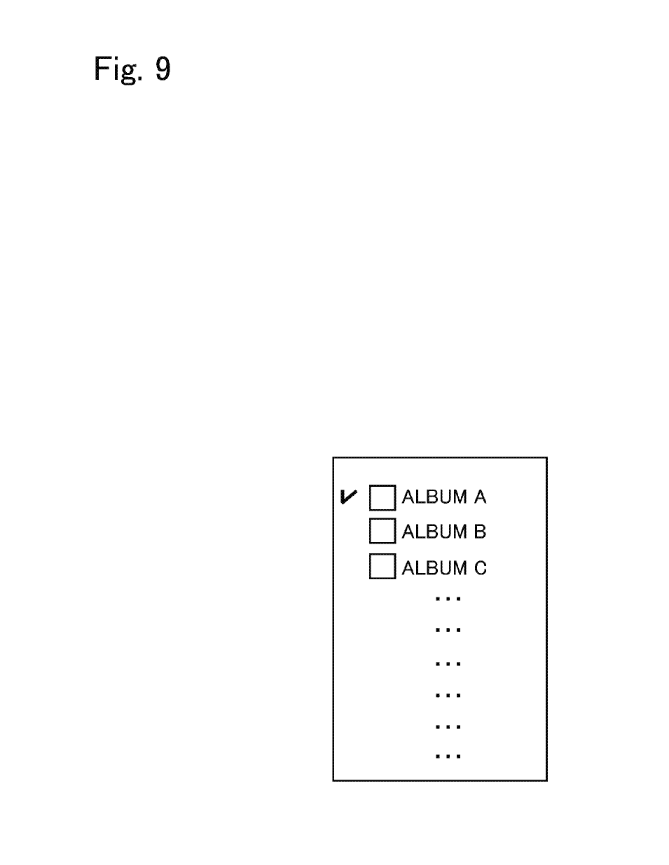

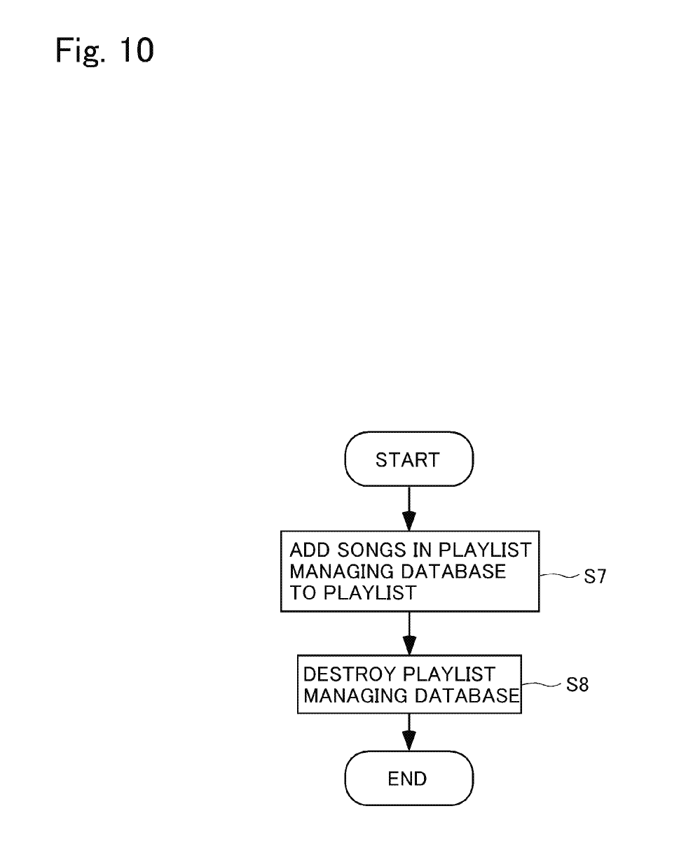

FIG. 7 is a flow chart illustrating processing operation in the case where the DAP 1 performs list obtaining processing. The CPU 2 obtains list of category (album and artist) (S4). The CPU 2 obtains all songs in each item (album and artist) from the obtained list (S5). When all obtained songs exist in the playlist managing database, the CPU 2 checks (S6). Thus, as illustrated in FIG. 8, when songs (titles A1 to A3) that are included in album A are selected, as illustrated in FIG. 9, album A is checked. FIG. 10 is a flow chart illustrating processing operation in the case the DAP 1 performs playlist save processing. The CPU 2 adds songs in the playlist managing database to the playlist (S7). Next, the CPU 2 destroys the playlist managing database (S8).

### Second Embodiment

The song database manages information of songs that are stored in managed folders. The CPU 2 registers information of songs in managed folders in the song database. The CPU 2 receives selection of songs that are added to the playlist among songs in the folder. As described above, the playlist managing database manages IDs and paths. The CPU 2 can specify a song by ID because it obtains information of the song list from the song database with regard to the song list of albums and artists.

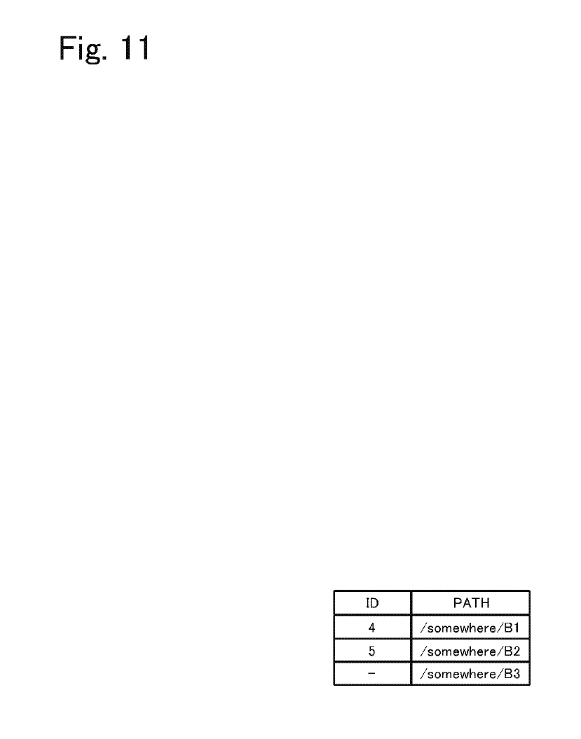

When a song is selected from the folder, a path is needed to specify the song because there is a case where information of the selected song is not managed by the song database. Therefore, when the song is selected from the song list of albums and artists, the CPU 2 obtains an ID and registers the obtained ID in the playlist managing database. On the other hand, when a song is selected from the song list in the folder, the CPU 2 obtains path of the selected song and obtains ID of the song based on the obtained path from the song database. And, the CPU 2 registers the ID and the path in the playlist managing database. When the CPU 2 cannot obtain the ID because information of the selected song is not registered in the song database, as illustrated in FIG. 11, it registers ID that indicates invalid such as NULL value (ID corresponding to path “/somewhere/B3” of FIG. 11).

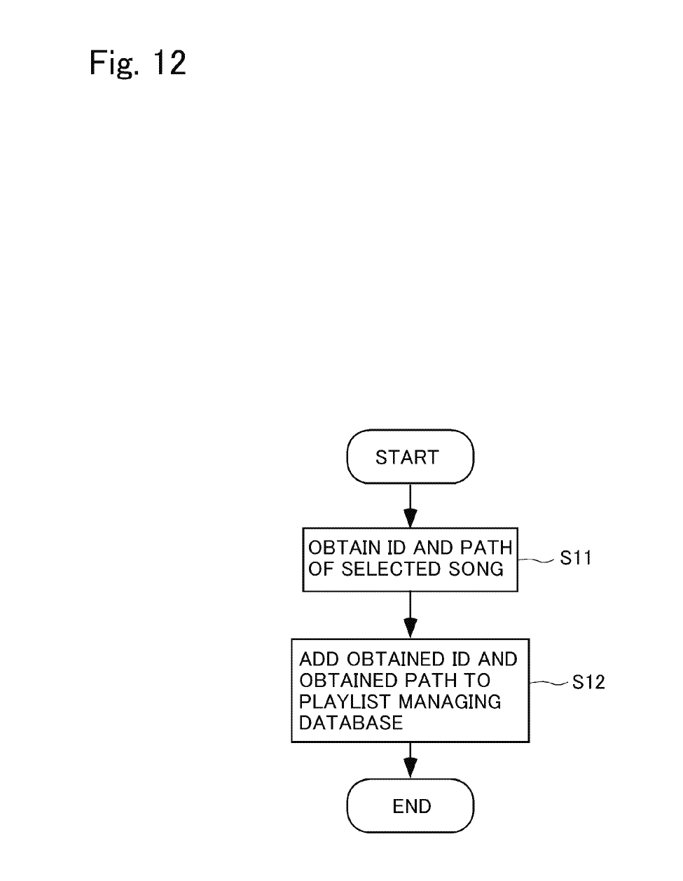

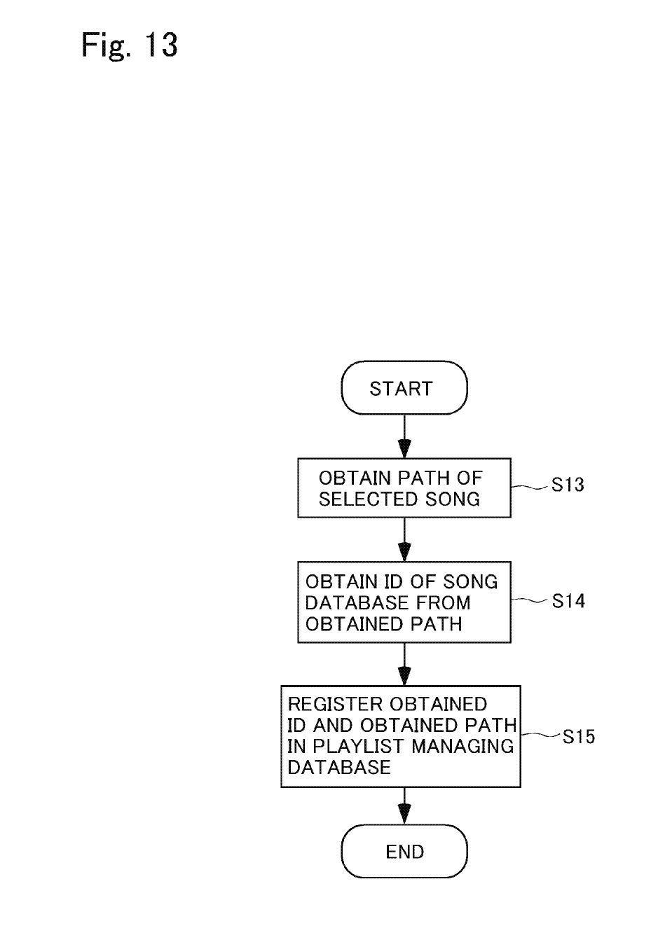

Playlist addition processing (FIG. 5), list obtaining processing (FIG. 7), and playlist save processing (FIG. 10) are the same as the first embodiment, and description is omitted. FIG. 12 is a flow chart illustrating processing operation in the case where the DAP 1 performs song selection processing from artists, albums or the like. The CPU 2 obtains ID and path of the selected song (S11). Next, the CPU 2 adds the obtained ID and the obtained path to the playlist managing database (S12). FIG. 13 is a flow chart illustrating processing operation in the case where the DAP 1 performs song selection processing from the folder. As illustrated in FIG. 13, the CPU 2 obtains path of the selected song (S13). Next, the CPU 2 obtains ID of the song database from the obtained path (S14). Next, the CPU 2 registers the obtained ID and path in the playlist managing database (S15). In S14, when the CPU 2 cannot obtain ID of the song database from the obtained path, namely, information of the song is not registered in the song database, it registers ID that indicates invalid and the obtained path in the playlist managing database.

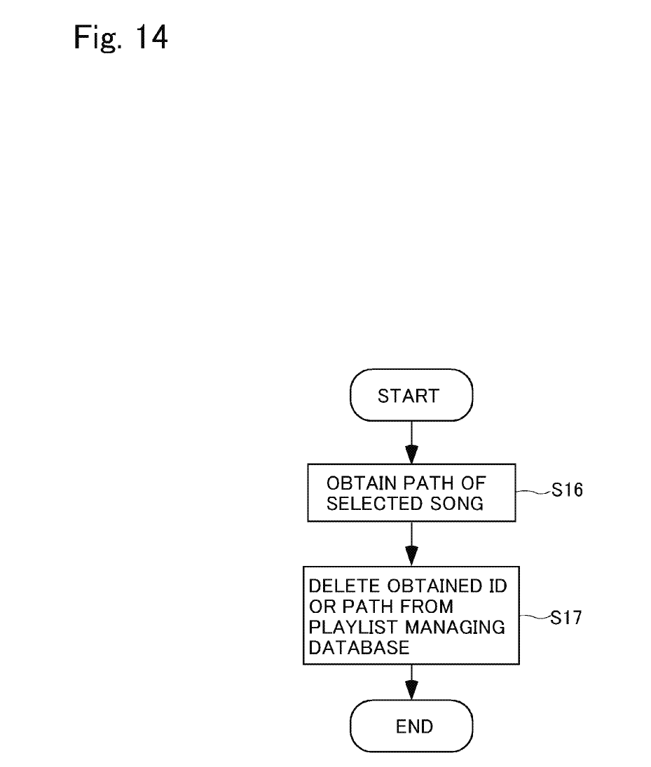

FIG. 14 is a flow chart illustrating processing operation in the case where the DAP 1 performs song release processing. The CPU 2 obtains path of a selected song (S16). The CPU 2 deletes the obtained ID or path from the playlist managing database (S17).

As described above, in the present embodiment, the CPU 2 combines the content database in the RAM 4 with the playlist managing database in the storage section 5. And, the CPU 2 issues SQL to the combined database, and obtains the song list to which the addition state to the playlist is reflected. Like this, information of check (selection) can be reflected to the content list correctly because the database is made in the RAM 4 and processing of the database can be performed quickly.

Further, in the present embodiment, there is a case where a selected song is not registered in the song database when a song is selected from the folder because information of a song in managed folders is registered in the song database. For this reason, path is needed to specify the song. Therefore, when the CPU 2 receives selection of a song from songs in the folder, it obtains path of the song that selection is received. Further, the CPU 2 obtains ID of the song from the song database based on the obtained path of the song. And, the CPU 2 registers the obtained path of the song and the obtained ID in the playlist managing database. Thus, it is displayed that the song that is selected from folders is already checked (selected). Reverse is also the same.

The embodiment of the present invention is described above, but the mode to which the present invention is applicable is not limited to the above embodiment and can be suitably varied without departing from the scope of the present invention.

In the above embodiment, the case where the music reproducing program P is installed in the DAP is described. Not limited to this, as a device that is functioned as a music reproducing device (a playlist making device), a smartphone, a tablet PC, a feature phone, a portable media player, a portable game device or the like may be employed.

The present invention can be suitably employed in a playlist making device that makes a playlist that designates reproducing order of contents.

What is claimed is:

1. A playlist making device comprising:
an auxiliary storage section that stores a content database that manages information of contents;
a main storage section; and
a controller;
wherein the controller makes a playlist managing database that manages a playlist in the main storage section,
registers information of a content that selection is received to the playlist managing database,
combines the content database with the playlist managing database,
issues a command to a combined database, and
obtains a content list to which a state of addition to the playlist is reflected.

2. The playlist making device according to claim 1,
wherein the controller obtains path of a content from the playlist managing database based on identification information of the content that selection is received and registers the obtained identification information and the obtained path of the content in the playlist managing database.

3. The playlist making device according to claim 2,
wherein the controller receives selection of a content that is added to the playlist from information of the contents that the content database manages,
obtains the path of the content from the playlist managing database based on the identification information of the content that selection is received when it receives selection of a content that is added to the playlist from information of the contents that the content database manages, and
registers the obtained identification information of the content and the obtained path of the content to the playlist managing database.

4. The playlist making device according to claim 1, wherein the controller registers information of the contents in managed folders to the content database,
receives selection of a content that is added to the playlist from the contents in the folder,
obtains the path of the content that selection is received when it receives selection of the content that is added to the playlist from the contents in the folder,
obtains identification information of the contents from the content database based on the path of the obtained content, and
registers the obtained path of the content and the obtained identification information of the content in the playlist managing database.

5. The playlist making device according to claim 4, wherein the controller registers the obtained path of the content and identification information of the content that indicates invalid when it cannot obtain identification information of the content from the content database based on the obtained path of the content.

6. The playlist making device according to claim 1, wherein the controller destroys the playlist managing database after it makes the playlist.

7. The playlist making device according to claim 1, wherein the command is SQL.

8. A storage medium in which a playlist making program is stored, the playlist making program allowing for a controller of a computer comprising:
an auxiliary storage section that stores a content database that manages information of contents;
a main storage section; and
the controller;
to make playlist managing database that manages a playlist in the main storage section,
to register information of a content that selection is received to the playlist managing database,
to combine the content database with the playlist managing database,
to issue a command to a combined database, and
to obtain a content list to which a state of addition to the playlist is reflected.
